(19) United States
(12) Patent Application Publication
(10) Pub. No.: US 2020/0015456 A1
(43) Pub. Date: Jan. 16, 2020

(54) MULTIDIRECTIONAL WEARABLE ANIMAL TRAINING APPARATUS

(71) Applicant: E-Collar Technologies, Inc., Garrett, IN (US)

(72) Inventors: Greg Van Curen, Fremont, IN (US); Ho-Sung So, Seoul (KR)

(73) Assignee: E-Collar Technologies, Inc., Garrett, IN (US)

(21) Appl. No.: 16/031,464

(22) Filed: Jul. 10, 2018

(51) Int. Cl. A01K 27/00; A01K 15/02

(52) U.S. Cl. CPC A01K 27/009; A01K 15/022; A01K 27/005; A01K 27/001; A01K 15/023

(57) ABSTRACT

An animal training apparatus is worn on an animal with a belt, to train the animal by delivering stimulus for behavior modification to the animal according to the animal's behavior. The animal training apparatus according to an aspect includes a pair of belt holders to securely hold the belt to the apparatus, each one in each of two facing side surfaces when the apparatus is viewed from the front, and at least one other pair of belt holders to change a direction in which the animal training apparatus is worn on the animal.

### TECHNICAL FIELD

The present disclosure relates to an apparatus that is worn on animals such as dogs to train the animals by delivering stimulus to the animals.

### BACKGROUND ART

An animal training apparatus is worn on an animal to train the animal by delivering stimulus such as electrical stimulus to the animal when the animal did or did not have a specific behavior, for example, the animal's bark or movement to a specific location.

For example, the conventional collar type animal training apparatus such as Patent Literature 1 is fixed by bringing a body into close contact with the neck part of the animal and fastening a belt to deliver stimulus to the neck part of the animal. The body of the animal training apparatus has a belt insertion hole in the shape of a slit in which the belt is securely held. The belt is inserted into a pair of belt insertion holes formed at the facing locations of the body, and is secured to the body.

Here, the conventional collar type animal training apparatus is worn on a fixed location of the animal, typically, on the neck, and the animal has tolerance to stimulus delivered to the fixed location over time. The animal training apparatus worn for a long term forms a callus at the fixed location of the animal that comes into contact with the part (e.g., an electrode) of the body and is subjected to stimulus. When a callus is formed at the fixed location, sensitivity to electrical stimulus of the same intensity reduces and the correction effect reduces.

Additionally, the conventional collar type animal training apparatus is impossible to connect the belt and the body when a belt holder on any one side is damaged, and even though there is no problem with the operation of the body, it cannot be worn on the animal.

### SUMMARY OF THE INVENTION

The present disclosure is designed to solve the problem of the related art, and therefore the present disclosure is directed to providing an animal training apparatus that can change directions in which the apparatus is worn on animals.

According to an aspect, an apparatus that is worn on an animal with a belt to train the animal by delivering stimulus for behavior modification to the animal according to the animal's behavior, includes a pair of belt holders to securely hold the belt to the apparatus, each one in each of two facing side surfaces when the apparatus is viewed from the front, and at least one other pair of belt holders to change a direction in which the apparatus is worn on the animal.

The belt holder includes a belt insertion hole in a shape of a slit into which the belt is inserted.

A guide is formed on an opposite side surface to a surface that touches the animal's body when the apparatus is worn on the animal, to allow the belt to go through one belt insertion hole and across covering the opposite side surface, and then to be inserted into and pass through an opposite belt insertion hole.

The guide is spaced apart a distance that is equal to or greater than a thickness of the belt on the opposite side surface to provide a space through which the belt passes.

Two pairs of belt insertion holes are provided in a direction perpendicular to each other, and the guide is fixed on the opposite side surface at a location in which the belt is not caught even though the belt is inserted into any pair of belt insertion holes and goes across the opposite side surface.

An electrode is provided on a surface that touches the animal's body when the apparatus is worn on the animal to deliver electrical stimulus to the animal.

The apparatus includes at least one sensor to detect the animal's bark or motion.

The apparatus includes a counter to count the number of times the stimulus is delivered to the animal.

The apparatus further includes a notification unit to notify the number of times counted by the counter exceeding a set critical number of times to a user.

According to an aspect of the present disclosure, when the apparatus is worn on an animal by changing directions in which the apparatus is worn, the animal's stimulus part is changed, thereby solving the problem with tolerance to stimulus on a previous stimulus part.

Additionally, according to another aspect of the present disclosure, when any one belt holder is damaged and the apparatus cannot be worn, the apparatus can be worn with a belt holder of a different direction, and accordingly the service life of the apparatus is extended.

### BRIEF DESCRIPTION OF DRAWINGS

The accompanying drawings illustrate the preferred embodiments of the present disclosure, and together with the following detailed description, serve to provide further understanding of the technical aspects of the present disclosure, and thus, the present disclosure is not construed as being limited to the drawings.

FIG. 1 is a schematic diagram showing the configuration of an animal training system according to an embodiment of the present disclosure.

FIG. 2 is a schematic diagram showing the internal configuration of an animal training apparatus of FIG. 1.

FIGS. 3a and 3b are diagrams showing an example of an animal training apparatus of FIG. 1 having a guide to allow a belt to be inserted in two directions to change an animal's stimulus part.

FIGS. 4 to 6 are diagrams showing examples of an animal training apparatus of FIG. 1 having guides of various shapes to allow a belt to be inserted in two directions.

### DETAILED DESCRIPTION FOR CARRYING OUT THE INVENTION

Hereinafter, the preferred embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation. The embodiment described herein and the illustration in the drawings is just a preferable example for the purpose of illustrations only and does not fully describe all the technical aspects of the present disclosure, so it should be understood that other equivalents and variations could be made thereto at the time the present application was filed.

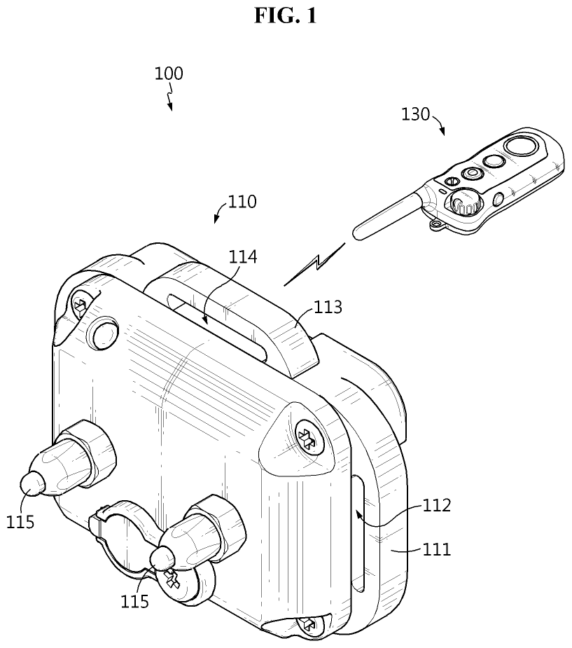

FIG. 1 is a schematic diagram showing the configuration of an animal training system 100 according to an embodiment of the present disclosure.

The animal training system 100 according to an embodiment of the present disclosure includes an animal training apparatus 110 and a remote controller 130.

The animal training apparatus 110 is worn on an animal with a belt to train the animal by delivering stimulus for behavior modification to the animal according to the animal's behaviors. The animal training apparatus 110 is not limited to a particular animal type (e.g., dogs, cats, cows, horses, etc.), a particular location in which the animal training apparatus 110 is worn (e.g., neck, belly, leg, etc.), or a particular animal behavior to be modified (e.g., barks, motions, location movements, etc.).

The animal training apparatus 110 has a pair of belt holders 111 on the two facing sides, when viewed from the front, to hold the belt. In addition to the pair of belt holders 111, the animal training apparatus 110 has at least one other pair of belt holders 113. Accordingly, the animal training apparatus 110 is configured to change the direction in which the animal training apparatus 110 is worn on the animal from one pair of belt holders 111 to the other pair of belt holders 113 or vice versa.

Here, each belt holder 111,113 includes a belt insertion hole 112,114 formed in the shape of a slit into which the belt is inserted. When the belt is securely held in the belt holders 111,113 using the pair of facing belt insertion holes 112,114, the animal training apparatus 110 is worn on the animal using the belt held securely.

For example, one pair of belt holders 111 facing in the left-right direction as shown in FIG. 1 allows the animal training apparatus 110 to be worn in horizontal state on the animal by the belt inserted into each belt insertion hole 112. The other pair of belt holders 113 facing in the up-down direction allows the animal training apparatus 110 to be worn in vertical state on the animal by the belt inserted into each belt insertion hole 114. Accordingly, after one pair of belt holders 111 is selected and the animal training apparatus 110 is worn on the animal, when a change to the other pair of belt holders 113 is made and the animal training apparatus 110 is worn on the animal, a change is made to the direction in which the animal training apparatus 110 is worn.

In this instance, the changed direction in which the animal training apparatus 110 is worn results in changes in the direction of a surface on which the animal training apparatus 110 comes into contact with the animal's body, the body contact location of a stimulus delivery means (e.g., an electrode 115 for delivering electrical stimulus) formed on the surface on which the animal training apparatus 110 is worn, and the location to which the animal training apparatus 110 delivers stimulus to the animal. The change in location of stimulus delivered to the animal removes the animal's tolerance to the delivered stimulus at the fixed stimulus location.

The stimulus allows the animal to differentiate an appropriate behavior from an inappropriate behavior. The stimulus includes various stimuli such as electrical stimulus for outputting electricity, vibration stimulus for outputting vibration by a motor, and audio stimulus for outputting audio through the speaker, and is not limited to a particular type.

For reference, although FIG. 1 shows the animal training apparatus 110 having the electrode 115 to output electrical stimulus, the stimulus of the present disclosure is not limited to electrical stimulus. The intensity and interval of stimulus the animal training apparatus 110 applies to the animal may be controlled, and weak intensity may be classified as an appropriate behavior and relatively strong intensity may be classified as an inappropriate behavior and set to the animal training apparatus 110.

The remote controller 130 communicates with the animal training apparatus 110 via wireless communication (e.g., radio frequency communication, infrared communication, Bluetooth communication, WiFi, etc.). In addition to the above-described communication function, the remote controller 130 may possess a user input function and an output function. The remote controller 130 gives commands to the animal training apparatus 110 according to the user's button input.

For example, a command for setting data to the animal training apparatus 110, a command for searching for data set to the animal training apparatus 110 and a command for delivering stimulus to the animal training apparatus 110 and controlling and/or stopping the stimulus may be given to the animal training apparatus 110 by the remote controller 130. Then, the animal training apparatus 110 performs an operation corresponding to the command received from the remote controller 130. Additionally, the remote controller 130 may wirelessly receive the command processing results from the animal training apparatus 110 and output to the user through a display or a speaker. Through output information, the user may see the operation condition of the animal training apparatus 110 and the condition of the animal. A smart phone or a smart watch having a wireless communication function may replace the remote controller 130 by downloading and executing a control application.

Meanwhile, the animal training system 100 may include the animal training apparatus 110 alone without the remote controller 130. Then, the animal training apparatus 110 may detect the animal's behavior, deliver stimulus according to the detected behavior, and output the operation condition through a display or a speaker.

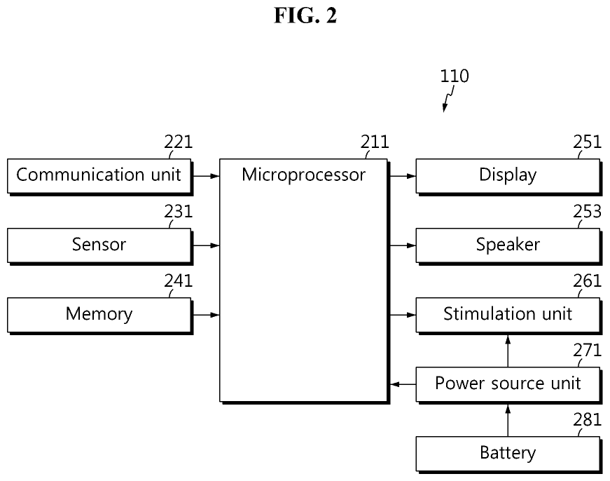

FIG. 2 is a schematic diagram showing the internal configuration of the animal training apparatus 110 of FIG. 1.

The animal training apparatus 110 according to an embodiment of the present disclosure includes a microprocessor 211, a communication unit 221, a sensor 231, a memory 241, a display 251, a speaker 253, a stimulation unit 261, a power source unit 271 and a battery 281.

The microprocessor 211 is a control unit of the present disclosure, and may control each component to operate according to the command received through the communication unit 221, and transmit the processing results through the communication unit 221. The microprocessor 211 compares the electrical signal received from the sensor 231 with the reference read from the memory 241, determines if it is a specific behavior of the animal, and when it is determined to be a specific behavior, outputs a control signal for stimulus delivery.

The communication unit 221 receives a wireless signal from the remote controller 130, and outputs the received signal to the microprocessor 211. Additionally, the communication unit 221 may send the wireless signal to the remote controller 130 in response to the control signal of the microprocessor 211.

The sensor 231 includes at least one sensor to detect the animal's behaviors. The animal's behavior may be classified into an appropriate behavior and an inappropriate behavior. The animal training apparatus 110 detects the animal's appropriate or inappropriate behavior through various sensors 231 when worn on the animal. A sensor having a unique sensing function may be determined according to the animal's specific behavior or condition to be detected from the animal. When an appropriate or inappropriate behavior is determined through the sensor 231, stimulus corresponding to the determined behavior may be delivered to the animal.

For example, a bark sensor may include sensors such as a piezoelectric element and a microphone element. A motion sensor may include an acceleration sensor and a gyro sensor.

Here, because the animal's behaviors and behavioral capability may vary depending on the type and size of the animal, it is preferred that the sensitivity of the sensor 231 can be set by the user. The user may set the sensitivity of the sensor 231 in the animal training apparatus 110 to the level of the animal's specific behavior through the manipulation of the remote controller 130 or the buttons of the animal training apparatus 110 when training the animal.

The memory 241 may store various types of data and processing logics to detect the animal's behaviors and deliver stimulus. The data stored in the memory 241 is read out and processed by the microprocessor 211.

The display 251 may display various pieces of information on the screen in response to the control signal outputted from the microprocessor 211. That is, various conditions or information of the animal and the animal training apparatus 110 may be outputted as visual information from the display 251. The user can see the animal's behavior condition, the number of times stimulus is delivered, and the normal or abnormal condition of the animal training apparatus 110 through the output of the display 251.

The speaker 253 outputs a corresponding signal tone in response to the control signal outputted from the microprocessor 211. In the case of simple signal tone output, the speaker 253 with low specification is sufficient, but for high quality output such as voice and music, the speaker 253 with high specification is required. By the signal tone output, the speaker 253 is a means for delivering audio stimulus to the animal or a means for notifying the animal's behavior condition to the user, the number of times stimulus is delivered and normal or abnormal condition of the animal training apparatus 110.

The stimulation unit 261 delivers various stimuli with different intensities and intervals to the animal according to the control signal outputted from the microprocessor 211. The stimulus delivery unit (e.g., the electrode 115) which outputs stimulus to the animal from the animal training apparatus 110, is in close contact with the animal's skin. In this instance, stimulus delivered by the stimulation unit 261 is delivered to the animal through the stimulus delivery unit, and the animal has a stimulus part fixed to the skin in contact with the stimulus delivery unit over time. The fixed stimulus part has a callus when subjected to the fixed stimulus, and thus sensitivity to stimulus reduces and tolerance develops. In this instance, when the insertion direction of the belt is changed by changing the belt holders 111, 113, the stimulus location of the stimulation unit 261 is changed and the animal's tolerance to the delivered stimulus at the fixed stimulus location may be removed.

The power source unit 271 receives power from the embedded battery 281, and supplies, for example, a 5V direct current power necessary to drive the microprocessor 211 and each circuit component and a direct current power necessary for the stimulation unit 261. When the stimulation unit 261 outputs electrical stimulus, the stimulation unit 261 receives low voltage power from the battery 281 through the power source unit 271, generates electrical pulse of low current high voltage (e.g., 50 VAC to 10,000 VAC) and delivers to the electrode 115. The animal's stimulus part in close contact with the electrode 115 is subjected to stimulus by the electrical signal. As the animal training apparatus 110 is worn on the animal for a long term, the stimulus part has tolerance to electrical stimulus.

The battery 281 may include a primary battery, and preferably includes a rechargeable secondary battery. The battery 281 may be charged using a separate component, a charging adaptor such as a USB cable. In addition to charging, the USB cable may perform function to set data to the animal training apparatus 110 and read the set data.

Hereinabove, the animal training apparatus 110 is manufactured with each component 211˜281 embedded in a housing, and is worn on the animal with the belt securely held in one pair of belt holders 111 or the other pair of belt holders 113.

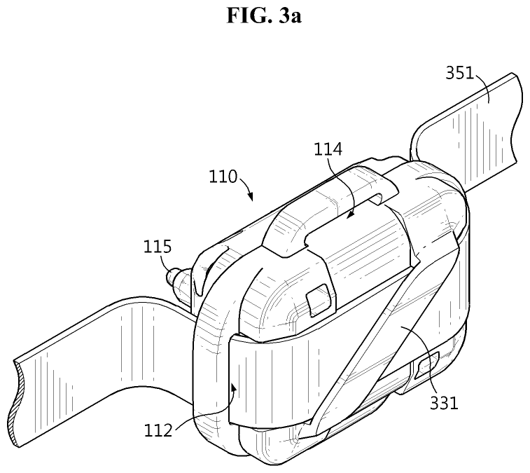

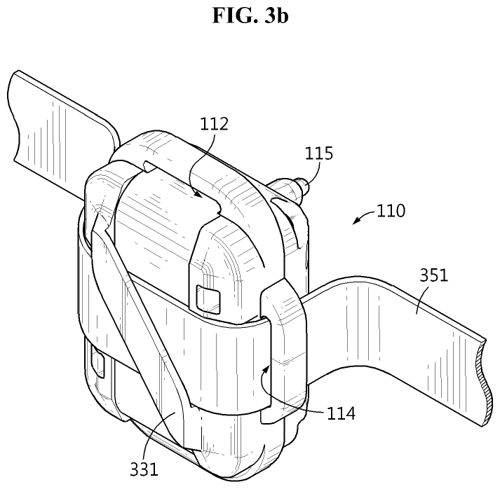

FIGS. 3a and 3b are diagrams showing an example of the animal training apparatus 110 having a guide 331 to allow a belt 351 to be inserted in two directions to change the animal's stimulus part.

Referring to FIG. 3a, the belt 351 inserted into a first belt insertion hole 112 on the left side of the animal training apparatus 110 passes through an opposite, second belt insertion hole 112 via the inner side of the guide 331. Here, a first insertion direction (left/right direction in the drawing) of the belt 351 passing through the first belt insertion hole 112, the guide 331 and the second belt insertion hole 112, may be changed to a second insertion direction (up/down direction in the drawing) of the belt 351 passing through a third belt insertion hole 114, the guide 331 and a fourth belt insertion hole 114 facing the third belt insertion hole 114.

On the opposite side surface to the surface on which the animal training apparatus 110 is worn, the guide 331 is spaced apart from the housing as much as a distance that is equal to or larger than thickness of the belt 351, to provide a space through which the belt 351 having passed through the first insertion hole 112 passes, covering the opposite side surface to the surface on which the animal training apparatus 110 is worn. The belt 351 having passed through the space is inserted into the opposite, second belt insertion hole 112 and securely held over the animal training apparatus 110.

Here, the guide 331 is configured to allow the belt 351 to pass through the space without being stuck even though any pair of belt insertion holes 112 is selected from the multiple pairs of belt insertion holes 112, 114 and the belt 351 is securely held. That is, the guide 331 allows the belt 351 to be securely held in any of multiple insertion directions.

Additionally, the guide 331 allows the belt 351 to come into close with the animal training apparatus 110. When the belt 351 is worn on the animal's neck, the belt 351 is tightened so that the surface of the animal training apparatus 110 being worn comes into closest contact with the animal. In this instance, in the case of the animal training apparatus 110 with no guide 331, a space may be formed between the animal training apparatus 110 and the belt 351. Due to this space, the belt 351 may be caught in a bulging or pointed article while the animal is doing activities. When the belt 351 is caught in a fixed structure, the animal cannot move, and while attempting to escape, the animal may be injured or throttled. Accordingly, by forming the guide 331 in the animal training apparatus 110, the belt 351 comes into closest contact with the animal training apparatus 110, thereby preventing the formation of the space.

Referring to FIG. 3b, the belt 351 inserted into the third belt insertion hole 114 along the second insertion direction in the animal training apparatus 110 passes through the fourth belt insertion hole 114 facing the third belt insertion hole 114 via the inner side of the guide 331.

With the change of the insertion direction of the belt 351 from the first direction passing through the first belt insertion hole 112 and the second belt insertion hole 112 to the second direction passing through the third belt insertion hole 114 and the fourth belt insertion hole 114, it results in a change in the part in which the animal is subjected to stimulus from the animal training apparatus 110. For example, in FIG. 3a, the electrode 115 forms a stimulus part in horizontal direction, and in FIG. 3b, the electrode 115 forms a stimulus part in vertical direction. When the stimulus part is changed with the change of the insertion direction of the belt 351, it is possible to solve the problem with tolerance to the repeated stimuli of the animal training apparatus 110 at stimulus part.

Here, the microprocessor 211 of the animal training apparatus 110 may count the time during which the animal training apparatus is worn or the number of times stimulus is delivered, and when the counted time or the counted number of times exceeds a critical reference, recommend the change in the insertion direction of the belt 351 to the user using the display 251 and/or the speaker 253, or by the remote controller 130. The user is recommended of the change in the insertion direction through the animal training apparatus 110 or the remote controller 130, and changes the insertion direction of the belt 351.

Additionally, even after the microprocessor 211 delivers stimulus through the stimulation unit 261, when the animal's inappropriate behavior is detected through the sensor 231, the user may be recommended of the change in the insertion direction of the belt 351 using the display 251 and the speaker 253. For example, after the microprocessor 211 delivers stimulus through the stimulation unit 261 with respect to the animal's specific behavior, when the number of times the animal's behavior requiring delivery of the same stimulus is detected through the sensor 231 is equal to or larger than a predetermined number of times within a predetermined unit time, the user may be notified of the change in the insertion direction. Accordingly, the microprocessor 211 can intelligently determine that the modification effect of stimulus for training the animal reduces and recommend the change in the insertion direction to the user.

Further, when any of the first belt insertion hole 112 and the second belt insertion hole 112 is damaged and the belt 351 cannot be worn in the first insertion direction, the animal training apparatus 110 can be worn on the animal in the second insertion direction through the remaining effective third belt insertion hole 114 and fourth belt insertion hole 114, thereby extending the service life of the animal training apparatus 110.

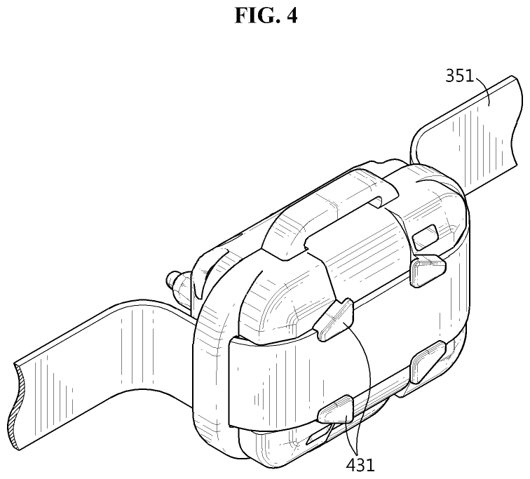

FIGS. 4 to 6 show examples of the animal training apparatus 110 of FIG. 1 having guides 431, 531, 631 of various shapes.

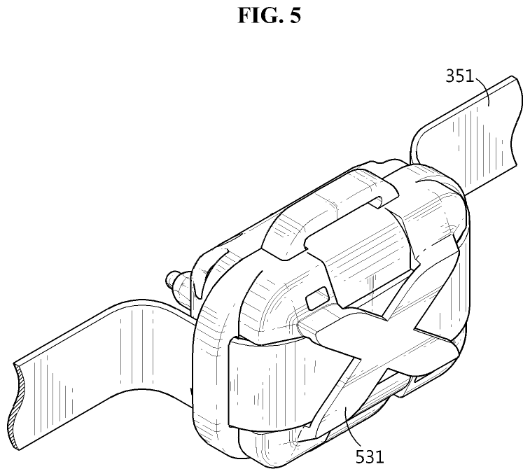

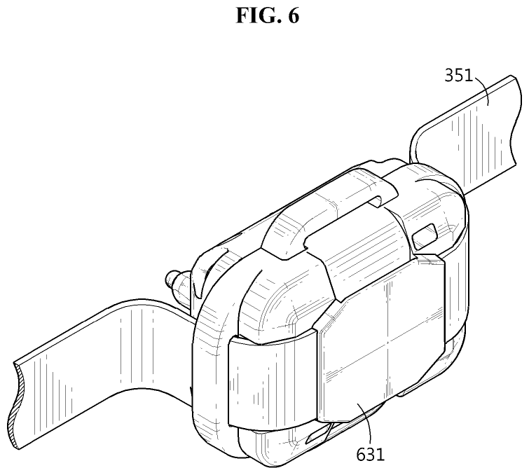

Referring to FIG. 4, shown are four guides 431 formed in the shape of a wing at square-shaped vertex locations of the animal training apparatus 110. Referring to FIG. 5, an X-shaped guide 531 is formed. Referring to FIG. 6, a rectangular plate-shaped guide 631 is shown. The guides 431, 531, 631 with each shape also accommodate, on the inner side thereof, the belt 351 that is inserted in the changed direction, and fixes the belt 351, covering the outer surface of the animal training apparatus 110.

While the present disclosure is described with respect to a limited number of embodiments and drawings, the present disclosure is not limited thereto, and it is obvious to those having ordinary skill in the technical field to which the present disclosure belongs that various modifications and changes may be made within the technical aspects of the present disclosure and the equivalent scope of the appended claims.

For example, although the above-described embodiment shows that the insertion direction of the belt 351 (the direction in which the apparatus is worn) is two perpendicular directions, the two directions do not need to be perpendicular to each other. Additionally, although two pairs (four) of belt insertion holes 112, 114 are shown and described, three pairs (six) of belt insertion holes may be formed and the insertion direction of the belt 351 may be three or more directions.

Additionally, although the above-described embodiment shows and describes that one belt 351 holds the animal training apparatus 110 through a pair of facing belt insertion holes 112, the belt may be securely held such that each one belt is fixed to each of the belt insertion holes 112 in a pair.

What is claimed is:

1. An animal training apparatus that is worn on an animal with a belt to train the animal by delivering stimulus for behavior modification to the animal according to the animal's behavior, comprising:
a pair of belt holders to securely hold the belt to the apparatus, each one in each of two facing side surfaces when the apparatus is viewed from the front; and
at least one other pair of belt holders to change a direction in which the apparatus is worn on the animal.

2. The animal training apparatus according to claim 1, wherein the belt holder includes a belt insertion hole in a shape of a slit into which the belt is inserted.

3. The animal training apparatus according to claim 2, wherein a guide is formed on an opposite side surface to a surface that touches the animal's body when the apparatus is worn on the animal, to allow the belt to go through one belt insertion hole and across covering the opposite side surface, and then to be inserted into and pass through an opposite belt insertion hole.

4. The animal training apparatus according to claim 3, wherein the guide is spaced apart a distance that is equal to or greater than a thickness of the belt on the opposite side surface to provide a space through which the belt passes.

5. The animal training apparatus according to claim 4, wherein two pairs of belt insertion holes are provided in a direction perpendicular to each other, and
the guide is fixed on the opposite side surface at a location in which the belt is not caught even though the belt is inserted into any pair of belt insertion holes and goes across the opposite side surface.

6. The animal training apparatus according to claim 1, wherein an electrode is provided on a surface that touches the animal's body when the apparatus is worn on the animal to deliver electrical stimulus to the animal.

7. The animal training apparatus according to claim 1, further comprising at least one sensor to detect the animal's bark or motion.

8. The animal training apparatus according to claim 1, further comprising a counter to count the number of times the stimulus is delivered to the animal.

9. The animal training apparatus according to claim 8, further comprising:
a notification unit to notify the number of times counted by the counter exceeding a set critical number of times to a user.
